(19) United States
(12) Patent Application Publication
(10) Pub. No.: US 2007/0131042 A1
(43) Pub. Date: Jun. 14, 2007

(54) Jig for durability test of joystick switch for vehicle

(75) Inventor: Yong Nam Kim, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/592,499

(22) Filed: Nov. 3, 2006

(30) Foreign Application Priority Data
Dec. 12, 2005 (KR) 10-2005-0121999

(51) Int. Cl. G01M 19/00

(52) U.S. Cl. 73/865.9; 324/415

(57) ABSTRACT

A jig for a durability test of a joystick switch for a vehicle includes a supporting member and an operating part comprises (a) an operating part having at least two artificial fingers configured to be able to grasp and push the joystick switch in a plurality of directions and being disposed to be opposite to each other, and (b) a supporting member to support the operating part.

### CROSS-REFERENCE TO RELATED APPLICATION

This application claims priority to and the benefit of Korean Patent Application No. 10-2005-0121999 filed in the Korean Intellectual Property Office on Dec. 12, 2005, the entire contents of which are incorporated herein by reference.

### BACKGROUND OF THE INVENTION

(a) Field of the Invention

The present invention relates to a jig for a durability test of a joystick switch for a vehicle.

(b) Background

Generally, a push switch or a rotary switch has widely been used as a switch for a vehicle. However, recently, as an information terminal having various functions is installed to a vehicle, a joystick switch is being developed as a multifunction switch.

Such a joystick switch is operable in four directions or in eight directions, and in addition, it is developed to have an enter function for a selection.

However, although a tester for testing a durability of a conventional push switch or a conventional rotary switch has been introduced, a tester for testing a durability of a joystick switch has not been introduced. For this reason, a durability test of a joystick switch has been performed using the tester for testing a durability of a push switch. However, since the tester for the push switch is designed to test a switch undergoing a linear motion, it is not suitable for a joystick switch which moves along with a circular arc.

Thus, it would desirable to have a tester for performing a durability test in the same way as operations of the joystick switch.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a jig for a durability test of a joystick switch for a vehicle.

An exemplary preferred embodiment of the present invention provides a jig for a durability test of a joystick switch for a vehicle where the jig comprises a supporting member and an operating part. The operating part preferably includes: (a) at least two artificial fingers configured to be able to grasp and push the joystick switch in a plurality of directions and being disposed to be opposite to each other; and (b) a supporting member to support the operating part.

More preferably, the operating part may further comprise: (a) a plate supported by the supporting member, arranged in a vertical direction and having a plurality of gear teeth thereon; (b) at least one linear driving member one end of which is fixed to the plate and extending to a forward direction; (c) at least one pushing shaft connected to the linear driving member and moving forward and rearward; and (d) at least one link member connecting the artificial fingers and the pushing shaft such that the artificial fingers operate in opposite directions.

The pushing shaft suitably may include a first pushing shaft and a second pushing shaft. The artificial fingers may suitably include an upper artificial finger and a lower artificial finger, which preferably are arranged to be opposite to each other in a vertical direction, and a left artificial finger and a right artificial finger, which are preferably arranged to be opposite to each other in a horizontal direction. The linear driving member may suitably include a first linear driving member connected to the first pushing shaft and configured to move the upper and the lower artificial fingers in opposite directions, and a second linear driving member connected to the second pushing shaft and configured to move the left and the right artificial fingers in opposite directions, and the first and the second linear driving members may respectively move the first and the second pushing shafts to advanced positions, neutral positions, and retreated positions.

The link member may suitably include: (a) a vertical center link arranged in a vertical direction, a center portion of which is pivotally connected to a fixed supporting member fixedly connected to the plate; (b) an upper connecting link and a lower connecting link respectively connected to an upper end of the vertical center link and an end of the upper artificial finger and to an lower end of the vertical center link and an end of the lower artificial finger; (c) a horizontal center link arranged in a horizontal direction, a center portion of which is pivotally connected to the fixed supporting member; (d) a left connecting link and a right connecting link respectively connected to a left end of the horizontal center link and an end of the left artificial finger and to a right end of the horizontal center link and an end of the right artificial finger; and (e) a first transmitting link connecting the first pushing shaft and one of the upper and the lower connecting links, and a second transmitting link connecting the second pushing shaft and one of the left and the right connecting links.

The linear driving member may further suitably include a third linear driving member disposed at a center portion of the plate. The pushing shaft may further suitably include a third pushing shaft connected to the third linear driving member so as to be movable forward and rearward, one end of which extends so as to be able to push a center of the joystick switch, thereby allowing a test operation of pushing the center of the joystick switch to be performed by forward and rearward movements of the third pushing shaft.

The linear driving member suitably may be a solenoid valve.

A circular arc rail including a circular arc guide extending in a circular arc shape suitably may be provided at the rear side of the artificial finger, and the circular arc extends along a guide hole formed in the artificial finger so that the artificial finger moves along the circular arc guide when the artificial finger moves by the link member.

The plate suitably may be rotatably supported by the supporting member, and may further comprise a driving part provided with a step motor rotating the plate.

The jig suitably may further include (a) a detection rod connected to a rotating axis of the plate, and (b) a switch configured to be switched according to an operation of the detection rod so as to detect rotation of the plate.

The step motor may be configured to rotate the plate by 45 degrees in a forward direction and in a reverse direction, such that operations of pushing the joystick switch in four directions by the first and the second linear driving members in a state that the plate is positioned at a reference position without being rotated are possible and operations of pushing the joystick switch in four directions by the first and the second linear driving members in a state that the pate is positioned at a position rotated preferably by about 45 degrees are possible, thereby the joystick switch being pushed in eight directions.

An operation of pushing the joystick switch in a forward direction by a forward and a rearward movements of the third pushing shaft caused by the third linear driving member may be performed after performing previous pushing operations in four directions at the reference position of the plate and pushing operations in four directions at a state in which the plate is rotated preferably by about 45 degrees and before performing subsequent pushing operations in four directions at the reference position of the plate and pushing operations in four directions at a state in which the plate is rotated preferably by about 45 degrees.

The jig suitably may further include a joystick gripping member grasping the joystick switch so that the artificial finger operates the joystick switch via the joystick gripping member.

As discussed, jigs as disclosed herein are jigs advantageously employed for a durability test of a joystick switch such as employed in a vehicle, particularly a motor vehicle.

It is understood that the term “vehicle” or other similar term as used herein is inclusive of motor vehicles in general such as passenger automobiles, buses, trucks, various commercial vehicles, and the like as well as watercraft and aircraft and the like.

Other aspects of the invention are disclosed infra.

### BRIEF DESCRIPTION OF THE DRAWINGS

FIG. 1A and FIG. 1B are perspective views of a jig for a durability test of a joystick switch for a vehicle according to an exemplary embodiment of the present invention.

FIG. 2 is a drawing showing a vertical operation of a jig for a durability test of a joystick switch for a vehicle according to an exemplary embodiment of the present invention.

FIG. 3A and FIG. 3B are drawings showing a horizontal operation of a jig for a durability test of a joystick switch for a vehicle according to an exemplary embodiment of the present invention.

FIG. 4 is a block diagram showing states during a test using a jig for a durability test of a joystick switch for a vehicle according to an exemplary embodiment of the present invention.

FIG. 5 is a flowchart of operation states in performing one cycle test using a jig for a durability test of a joystick switch for a vehicle according to an exemplary embodiment of the present invention.

Reference numerals set forth in the Drawings includes reference to the following elements as further discussed below:

| | | | |
|---|---|---|---|
| 1: | joystick switch | 10: | operating part |
| 10-1: | rotating axis | 11: | plate |
| 12: | artificial finger | 13: | circular arc rail |
| 14: | first pushing shaft | 15: | second pushing shaft |
| 16: | third pushing shaft | 17: | solenoid valve |
| 18: | switch | 18-1: | first switch |
| 18-2: | second switch | 19: | detection rod |
| 20: | driving part | 22: | driving gear |
| 24: | step motor | 30: | supporting member |

### DETAILED DESCRIPTION

In preferred aspects, a jig is provided which can be employed for a durability test of a joystick switch for a vehicle. Preferred jigs of the invention may suitably comprise a supporting member and an operating part. The operating part preferably may comprise: (a) at least two artificial fingers configured to be able to grasp and push the joystick switch in a plurality of directions and being disposed to be opposite to each other; and (b) a supporting member to support the operating part.

More preferably, the operating part may further comprise: (a) a plate supported by the supporting member, arranged in a vertical direction and having a plurality of gear teeth thereon; (b) at least one linear driving member one end of which is fixed to the plate and extending to a forward direction; (c) at least one pushing shaft connected to the linear driving member and moving forward and rearward; and (d) at least one link member connecting the artificial fingers and the pushing shaft such that the artificial fingers operate in opposite directions.

Preferred artificial fingers of the invention may suitably comprise an upper finger, a lower finger, a left finger and a right finger, wherein the upper and lower fingers are arranged to be opposite to each other in a vertical direction and the left and right fingers are arranged to be opposite to each other in a horizontal direction.

Another preferred artificial fingers may comprise a circular arc rail having a circular arc guide at the rear side of the finger, the circular arc extending along with a guide hole formed in the finger so that the finger can move along with the circular arc guide when the link member moves the finger moves.

Suitably, pushing shafts may comprise a first pushing shaft and a second pushing shaft. If desired and/or necessary, additional pushing shafts, such as a third pushing shaft, can be provided.

A preferred linear driving member may comprise a first linear driving member connected to the first pushing shaft and configured to move the upper and the lower fingers in opposite direction, and a second linear driving member connected to the second pushing shaft and configured to move the left and the right artificial fingers in opposite direction.

The first and the second linear driving members may suitably be configured to respectively move the first and the second pushing shafts to advanced positions, neutral positions, and retreated positions.

Another preferred linear driving member may further comprise a third linear driving member disposed at a center portion of the plate. In one embodiment, as discussed, the pushing shaft may further comprise a third pushing shaft and the third pushing shaft may suitably be connected to the third linear driving member so as to be movable forward and rearward, one end of which extends so as to be able to push a center of the joystick switch, allowing a test operation of pushing the center of the joystick switch to be performed by forward and rearward movements of the third pushing shaft.

A preferred example of the linear driving member may include, not limited to, a solenoid valve.

In a preferred embodiment, link members may comprise: (a) a vertical center link arranged in a vertical direction, a center portion of which is pivotally connected to a fixed supporting member fixedly connected to the plate; (b) an upper connecting link and a lower connecting link respectively connected to an upper end of the vertical center link and an end of the upper artificial finger and to an lower end of the vertical center link and an end of the lower artificial finger; (c) a horizontal center link arranged in a horizontal direction, a center portion of which is pivotally connected to the fixed supporting member; (d) a left connecting link and a right connecting link respectively connected to a left end of the horizontal center link and an end of the left artificial finger, and to a right end of the horizontal center link and an end of the right artificial finger; and (e) a first transmitting link connecting the first pushing shaft and one of the upper and the lower connecting links, and a second transmitting link connecting the second pushing shaft and one of the left and the right connecting links.

Suitably, plate may be rotatably supported by the supporting member.

Still another preferred jigs of the present invention may further comprise driving part connected to the operating part, which is adapted to be able to move the operating part in a plurality of directions. Preferably, the driving part may also comprise a step motor rotating the plate. More preferably, the driving part may further comprise a driving gear the teeth of which are configured to fit the teeth of the plate.

A preferred step motor may suitably be configured to rotate the plate by 45 degrees in a forward direction and in a reverse direction, such that operations of pushing the joystick switch in four directions by the first and the second linear driving members in a state that the plate is positioned at a reference position without being rotated are possible and operations of pushing the joystick switch in four directions by the first and the second linear driving members in a state that the pate is positioned at a position rotated by 45 degrees are possible, thereby allowing the joystick switch to be pushed in eight directions.

Preferably, an operation of pushing the joystick switch in a forward direction by a forward and a rearward movements of the third pushing shaft caused by the third linear driving member can be performed after performing previous pushing operations in four directions at the reference position of the plate and pushing operations in four directions at a state in which the plate is rotated by 45 degrees and before performing subsequent pushing operations in four directions at the reference position of the plate and pushing operations in four directions at a state in which the plate is rotated by 45 degrees.

In yet another preferred embodiment, operating part may further comprise (a) a detection rod connected to a rotating axis of the plate, and (b) a switch configured to be switched according to an operation of the detection rod so as to detect rotation of the plate.

An exemplary embodiment of the present invention will hereinafter be described in detail with reference to the accompanying drawings.

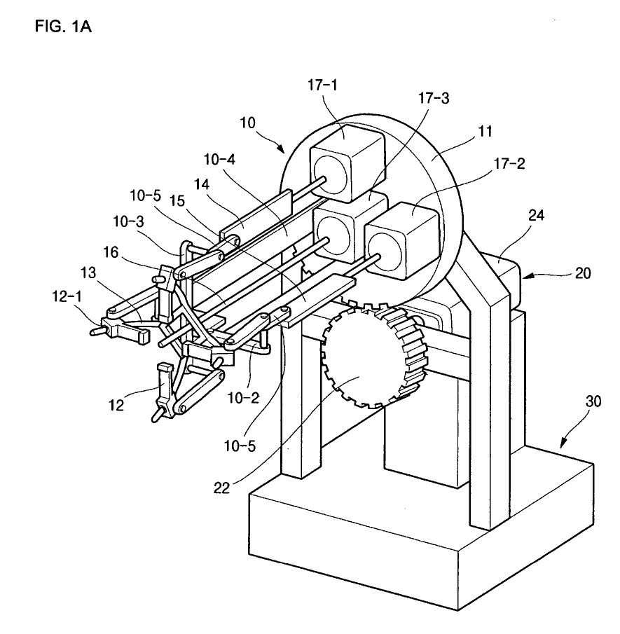

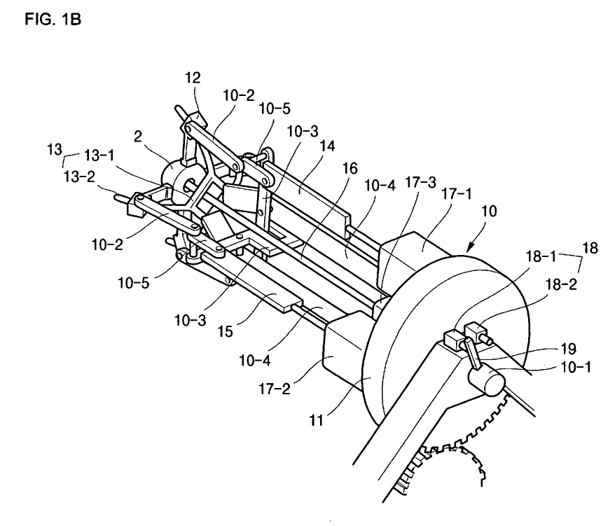

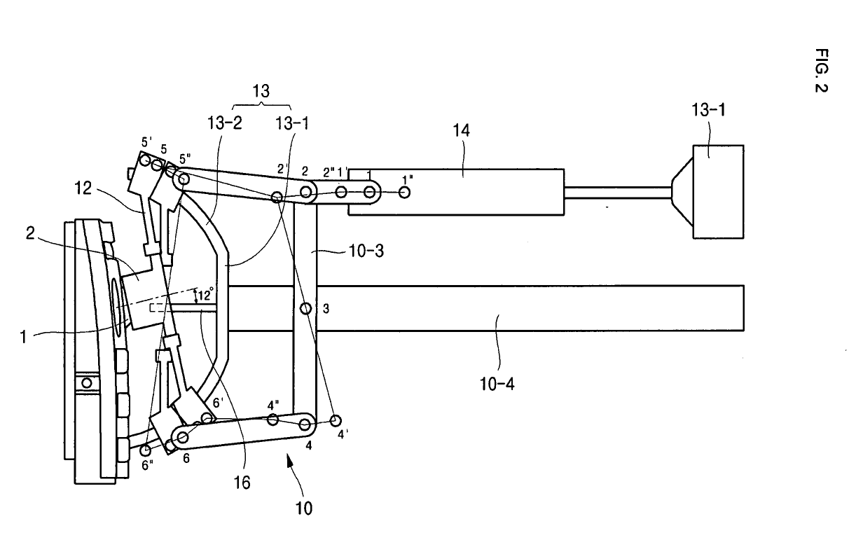

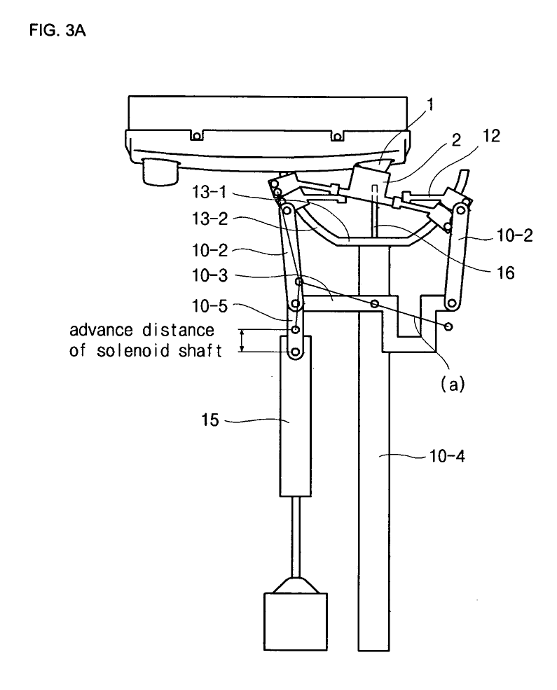

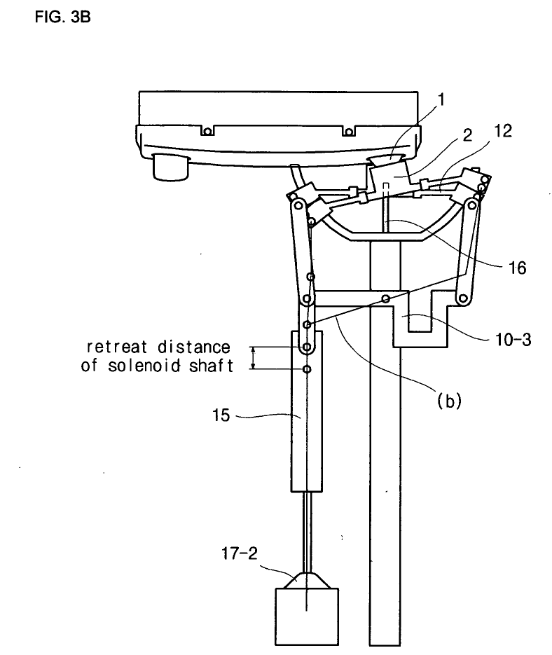

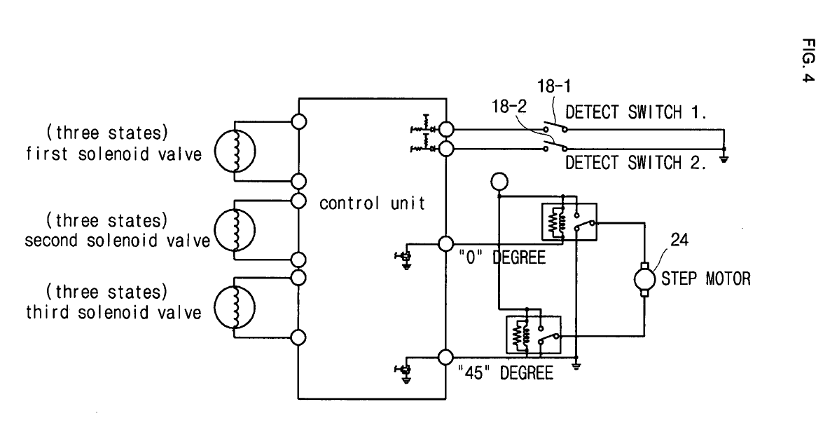

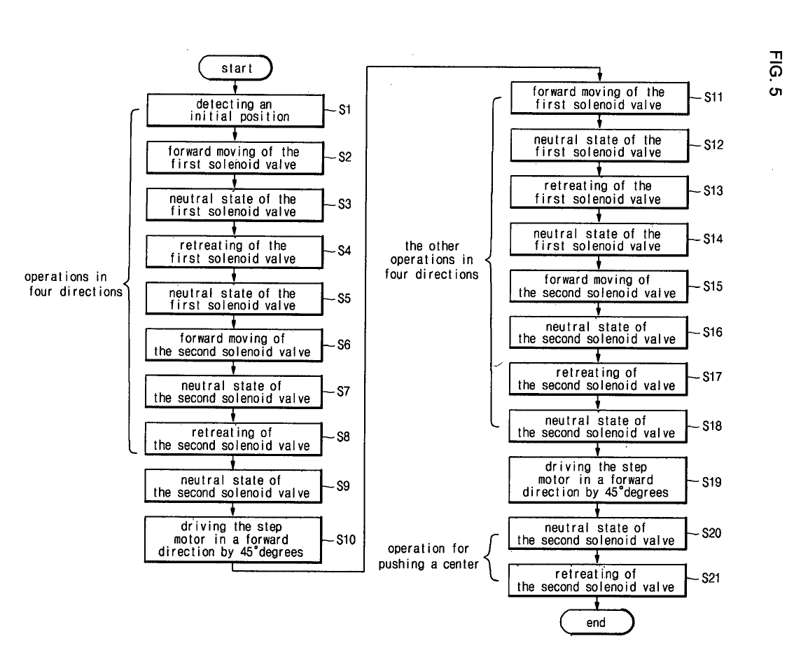

FIG. 1A and FIG. 1B are perspective views of a preferred jig for a durability test of a joystick switch for a vehicle according to an exemplary embodiment of the present invention. FIG. 2 is a drawing showing a vertical operation of a jig for a durability test of a joystick switch for a vehicle according to an exemplary embodiment of the present invention. FIG. 3A and FIG. 3B are drawings showing a horizontal operation of a jig for a durability test of a joystick switch for a vehicle according to an exemplary embodiment of the present invention. FIG. 4 is a block diagram showing states during a test using a jig for a durability test of a joystick switch for a vehicle according to an exemplary embodiment of the present invention. FIG. 5 is a flowchart of operation states in performing one cycle test using a jig for a durability test of a joystick switch for a vehicle according to an exemplary embodiment of the present invention.

Referring to the drawings, a jig for a durability test of a joystick switch for a vehicle according to an exemplary embodiment of the present invention includes an operating part 10, a driving part 20 provided with a step motor 24, and a supporting member 30.

The operating part 10 is supported by the supporting member 30, and the operating part 10 is configured to perform a durability test of a joystick switch 1 while being rotated by the driving part 20. According to an exemplary embodiment of the present invention, the operating part 10 is configured to perform an operation test in four directions in a state of holding the joystick switch 1. Where a plate 11 is configured to be rotatable by the driving part 20, an operation test can be performed in four more directions, meaning that the operation test can be performed in eight directions. In addition, the operating part 10 is configured such that a center push operation, i.e., an enter operation, pushing the joystick switch 1 in a front direction is possible.

According to an exemplary embodiment of the present invention, the operating part 10 includes a plate 11, an artificial finger 12, a circular arc rail 13, pushing shafts 14, 15, and 16, and solenoid valves 17-1, 17-2, and 17-3.

The plate 11 is configured to be rotatable by the step motor 24 of the driving part 20. In the present exemplary embodiment, the plate 11 is formed as a circular plate, and is provided with gear teeth on its outer circumference. The plate 11 is engaged with a driving gear 22 connected to the step motor 24 so as to rotate with respect to a rotating axis 10-1 by the driving of the step motor 24.

In an exemplary embodiment of the present invention, four artificial fingers 12 can be used, and the plate 11 can be rotated forwardly and reversely by 45 degrees so as to operate the joystick switch 1 in eight directions. In this case, the gear teeth engaged with the driving gear 12 may be formed only a corresponding portion of the outer circumference of the plate 11.

In an exemplary embodiment of the present invention, the four artificial fingers 12 may be formed in front of the plate 11, and the four artificial fingers 12 may be configured to grasp the joystick switch 1 so as to be able to perform a durability test. The artificial finger 12 can be linked with the plate 11 so as to rotate together with the plate 11, and can receive operations of the solenoid valves 17-1 and 17-2 via link members so as to repeat operations pushing an upper portion, a lower portion, a left portion, and a right portion of the joystick switch 1, thereby performing a durability test of the joystick switch 1.

The artificial finger 12 is connected via link members to the pushing shafts 14 and 15 which move forward and rearward by the solenoid valves 17-1 and 17-2. Connections of the upper and the lower artificial fingers 12 among the four artificial fingers 12 are as follows. A center link 10-3 is disposed in a vertical direction, and a center of the center link 10-3 is pivotally connected to a fixed supporting member 10-4 an end of which is connected to the plate 11 and which extends in a front direction. An end of a transmitting link 10-5 is pivotally connected to an end portion of the first pushing shaft 14 which moves forward and rearward by the first solenoid valve 17-1 mounted to an upper portion of the plate 11, and the transmitting link 10-5 extends in a front direction. An end of an upper connecting link 10-2 is pivotally connected to an end portion of the upper artificial finger 12, and the upper connecting link 10-2 extends in a rearward direction. The other ends of the upper connecting link 10-2 and the transmitting link 10-5 are respectively pivotally connected to an end portion of the center link 10-3 via a connecting axis. The lower artificial finger 12 is connected to the center link 10-3 via the lower connecting link 10-2 which is pivotally connected to the other end of the center link 10-3 via a connecting axis. That is, the connections between the center link 10-3, the connecting links 10-2, and the artificial fingers 12 are symmetry with respect to an imaginary horizontal surface passing a center of the center link 10-3.

If the first pushing shaft 14 moves forward by the operation of the first solenoid valve 17-1, the transmitting link 10-5 also moves forward, and accordingly, the upper connecting link 10-2 moves forward and the lower connecting link 10-2 moves rearward by link connections, thereby moving the upper artificial finger 12 forward and the lower artificial finger 12 rearward, respectively. Accordingly, an upper push operation of pushing an upper portion of the joystick switch 1 occurs by the upper artificial finger 12. In contrast, if the first pushing shaft 14 moves rearward by the operation of the first solenoid valve 17-1, the upper artificial finger 12 moves rearward and the lower artificial finger 12 moves forward in a similar principle, so that a lower push operation of pushing a lower portion of the joystick switch 1 occurs.

Connections of the artificial fingers 12, which are horizontally arranged, are equal to the connections of the artificial fingers 12 which are vertically arranged, except the disposition directions, i.e., the center link 10-3 is horizontally disposed, and a center of the center link 10-3 are pivotally connected to the fixed supporting member 10-4. The connecting links 10-2 pivotally connected to the left and the right artificial fingers 12 are pivotally connected to end portions of the center link 10-3 horizontally disposed, and right end portions of the right connecting link 10-2 and the center link 10-3 are pivotally connected to the transmitting link 10-5 connected to the second pushing shaft 15 via a connecting axis. Accordingly, if the second pushing shaft 15 moves forward by the operation of the second solenoid valve 17-2 disposed at a right portion of the plate 11, the right artificial finger 12 moves forward and the left artificial finger 12 moves rearward, thereby pushing a right portion of the joystick switch 1. In contrast, if the second pushing shaft 15 moves rearward, a left portion of the joystick switch 1 is pushed.

Guide holes 12-1 are respectively formed in the four artificial fingers 12, and the circular arc rail 13 extends in the guide hole 12-1. Accordingly, the circular arc rail 13 guides the movements of the artificial finger 12.

The circular arc rail 13 is disposed at the rear side of the artificial finger 12, and is attached to the fixed supporting member 10-4 so as to be supported by the same. A center portion 13-1 of the circular arc rail 13 is formed in a quadrangle shape, and circular arc guides 13-2 are respectively formed by being extended from corners of the center portion 13-1 in a circular arc shape. The circular arc guides 13-2 are respectively inserted into the guide holes 12-1 of the artificial fingers 12. Accordingly, the artificial finger 12 moves in a locus of a circular arc along the circular arc guide 13-2.

The first pushing shaft 14 serves to vertically push the joystick switch 1, and is pivotally connected to the upper first connecting link 10-2 and the center link 10-3 via the transmitting link 10-5. The first pushing shaft 14 moves forward and rearward by the first solenoid valve 17-1 mounted to an upper portion of the plate 11 so as to operate the artificial finger 12, so that the joystick switch 1 is pushed in a vertical direction so as to perform a durability test. The first solenoid valve 17-1 may be mounted to a lower portion of the plate 11, and in this case, the first pushing shaft 14 is connected to the lower connecting link 10-2 via the transmitting link 10-5.

The second pushing shaft 15 serves to horizontally push the joystick switch 1, and is pivotally connected to the first connecting link 10-2 and the center link 10-3 arranged in a horizontal direction via the transmitting link 10-5. The second pushing shaft 15 moves forward and rearward by the second solenoid valve 17-2 mounted to a right portion of the plate 11 so as to operate the artificial finger 12, so that the joystick switch 1 is pushed in a horizontal direction so as to perform a durability test. The second solenoid valve 17-2 may be mounted to a left portion of the plate 11, and in this case, the second pushing shaft 15 is connected to the left connecting link 10-2 via the transmitting link 10-5.

The jig for a durability test of a joystick switch for a vehicle according to an exemplary embodiment of the present invention is configured to perform a center pushing operation test in addition to four or eight directions pushing operation test.

For this, the third solenoid valve 17-3 is mounted to a center portion of the plate 11, and the third pushing shaft 16 is connected to the third solenoid valve 17-3 and extends forward. The third pushing shaft 16 passes through the center portion 13-1 of the circular arc rail 13, and extends to a center of the artificial fingers 12.

Accordingly, the third pushing shaft 16 moves forward and rearward by the third solenoid valve 17-3 so as to push the joystick switch 1 forward.

In an exemplary embodiment of the present invention, as described above, the solenoid valves 17-1, 17-2, and 17-3 sequentially operate so as to move the first pushing shaft 14, the second pushing shaft 15, and the third pushing shaft 16 forward. While the first and the second pushing shafts 14 and 15 move between an advanced position, a neutral position, and a retreated position, forward/rearward pushing tests and left/right push tests are performed. And while the third pushing shaft 16 moves between an advanced position and a neutral position, a center pushing test is performed.

The jig for a durability test of a joystick switch for a vehicle according to an exemplary embodiment of the present invention includes a switch 18 disposed at a rear side of the plate 11 and sensing rotation of the operating part 10 including the plate 11 as the driving part 20.

The switch 18 includes a first switch 18-1 and a second switch 18-2. The first switch 18-1 senses a state in which the plate 11 is in a reference position, i.e., 0 degrees of a rotation angle, and the second switch 18-2 senses a state in which the plate 11 is rotated by 45 degrees.

A detection rod 19 is connected to a rotating axis 10-1 extending to a rearward direction of the plate 11. The detection rod 19 rotates together with the plate 11 so as to operate the first switch 18-1 and the second switch 18-2, thereby detecting a rotation of the plate 11. An operating signal is supplied to a control unit according to operation of the switch 18, and the control unit controls the rotation of the plate 11 on the basis of the operation signal.

That is, when the plate 11 is positioned at the reference position, i.e., at a rotation angle of 0 degree, the detection rod 19 contacts the first switch 18-1, so that it is detected that the plate 11 is positioned at the reference position. Meanwhile, when the plate 11 is rotated by 45 degrees, the detection rod 19 contacts the second switch 18-2, so that is it is detected that the plate 11 is rotated by 45 degrees.

Accordingly, in the case that a test is performed using the jig for a durability test of a joystick switch for a vehicle according to an exemplary embodiment of the present invention, by moving the first and the second pushing shafts 14 and 15 between the advanced position, the neutral position, and the retreated position while the plate 11 is positioned at the reference position (0 degree of a rotation angle), push tests in directions of 0°, 180°, 270°, and 90° can be performed in the case when the plate 11 and the joystick switch directly face each other, and by moving the first and the second pushing shafts 14 and 15 between the advanced position, the neutral position, and the retreated position after the plate 11 is rotated by 45°, push tests in directions of 45°, 225°, 315°, and 135° can be performed in the case when the plate 11 and the joystick switch directly face each other. In addition, by moving the third pushing shaft 16 between the advanced position, the neutral position, and the retreated position, the center push operating test can be performed.

Furthermore, if necessary, push tests in more than eight directions can be performed by controlling the rotation of the plate 11.

The jig for a durability test of a joystick switch for a vehicle according to an exemplary embodiment of the present invention may further include a joystick switch gripping member 2 preventing damages on the joystick switch 1 and firmly holding the joystick switch 1 during the durability test so as to precisely deliver a driving force to an operating direction of the artificial finger 12.

The joystick switch 1 in a knob type is inserted into the joystick gripping member 2, and the artificial finger 12 is mounted to grasp the joystick gripping member 2. Accordingly, an operation of the artificial finger 12 to push the joystick gripping member 2 in one direction is delivered to the joystick switch 1 via the joystick gripping member 2, thereby pushing the joystick switch 1 in one direction. That is, the artificial finger 12 operates the joystick switch 1 via the joystick gripping member 2.

As described above, the driving part 20 includes the driving gear 22 and the step motor 24. The step motor 24 repeats rotations of 45 degrees in a forward direction and in a reverse direction on the basis of the detecting signal of the switch 18, thereby rotating the plate 11 to be repeatedly positioned at the reference position and at the rotated position by 45 degrees. The control unit controls such operations of the step motor 24 on the basis of the detecting signal of the switch 18.

The supporting member 30 serves to support the operating part 10 and the driving part 20.

Push operations of the joystick switch 1 in a vertical direction by the jig for a durability test of a joystick switch for a vehicle according to an exemplary embodiment of the present invention will now be explained with reference to FIG. 2.

First, the operation pushing an upper portion of the joystick switch 1 will be explained. If the first pushing shaft 14 moves forward by the first solenoid valve 17-1 at a neutral state of the joystick switch 1, a first link point, which is a pivotal connection point of the first pushing shaft 14 and the transmitting link 10-5, moves from a point 1 to a point 1′. Accordingly, a second link point, which is a pivotal connection point of the center link 10-3, the upper connecting link 10-2, and the transmitting link 10-5, moves forward from a point 2 to a point 2′. At this time, since a center of the center link 10-3 is pivotally connected to the fixed supporting member 10-4 at a third link point, a fourth link point, which is a pivotal connection point of the lower connecting link 10-2 and the center link 10-3, moves rearward from a point 4 to a point 4′.

Accordingly, a fifth link point, which is a connection point of the upper artificial finger 12 and the upper connecting link 10-2, moves from a point 5 to a point 5′, a sixth link point, which is a connection point of the lower artificial finger 12 and the lower connecting link 10-2, moves from a point 6 to a point 6′. At this time, since the upper and lower artificial fingers 12 moves along the circular arc rail 13, the fifth and the sixth link points also move along a circular arc curve.

At this time, a position of the third link point does not move.

If the artificial finger 12 moves along the circular arc rail 13 as described above, the joystick gripping member 2 and the joystick switch 1 rotate upwardly by 12 degrees, so that the joystick switch 1 is pushed in a direction of 0 degree, i.e., an upper portion of the joystick switch 1 is pushed.

After the operation of pushing an upper portion, the first pushing shaft 14 moves rearward so as to be positioned to the neutral position by the operation of the first solenoid valve 17-1, so that link points move respectively from points 1′, 2′, 4′, 5′, and 6′ to points 1, 2, 4, 5, and 6.

Next, the operation pushing a lower portion of the joystick switch 1 will be explained.

If the first pushing shaft 14 moves rearward from the neutral position by the operation of the first solenoid valve 17-1, the first link point moves from a point 1 to a point 1″, the second link point moves from a point 2 to a point 2″, the fourth link point moves from a point 4 to a point 4″, the fifth link point moves from a point 5 to a point 5″, and the sixth link point moves to a point 6 to a point 6″.

At this time, the position of the third link point does not move.

Accordingly, if the artificial finger 12 moves along the circular arc rail 13 as described above, the joystick gripping member 2 and the joystick switch 1 rotates downwardly by 12 degrees, so that the joystick switch 1 is pushed in a direction of 180 degrees, i.e., a lower portion of the joystick switch 1 is pushed.

After the operation of pushing the lower portion of the joystick switch 1, the first pushing shaft 14 moves forward by the operation of the first solenoid valve 17-1 so as to return to the neutral position, and thereby respective link points return to neutral positions.

Here, an operating angle and an operating force of the jig for a durability test of a joystick switch for a vehicle according to an exemplary embodiment of the present invention can be varied according to specifications of the joystick switch 1.

Operations for pushing left and right portions of the joystick switch 1 by the jig for a durability test of a joystick switch for a vehicle according to an exemplary embodiment of the present invention will be explained with reference to FIG. 3A and FIG. 3B.

The operations for pushing the left and the right portions of the joystick switch 1 has the same operating principle as that of the operations for pushing the upper and the lower portion of the joystick switch 1, but operated elements are different. For better comprehension, the operations will be explained in view of connection lines of link members rather than the movements of the link points used for the description of FIG. 2.

As shown in FIG. 3A, if the second solenoid valve 17-2 makes the second pushing shaft 15 moves forward. At this time, the second pushing shaft 15 moves forward by an advance distance of a solenoid pushing shaft, so that a connection line of the link members is changed to a state (a).

Accordingly, the artificial finger 12 moves along the circular arc rail 13, and thereby the joystick switch 1 rotates to a left direction by 12 degrees, so that the operation of pushing the left portion of the joystick switch 1 is performed.

In contrast, if the second solenoid valve 17-2 makes the second pushing shaft 15 move rearward at the neutral state of the joystick switch 1, the second pushing shaft 15 retreats by a retreat distance of a solenoid pushing shaft, so that a connection line of the link members is changed to a state of (b).

Accordingly, if the artificial finger 12 moves along the circular arc rail 13, the joystick switch 1 rotates to the right direction by 12 degrees, so that the right portion of the joystick switch 1 is pushed.

Meanwhile, if the third pushing shaft 16 moves forward by an advance distance of a solenoid pushing shaft of the third solenoid valve 17-3 at the neutral states of the first pushing shaft 14 and the second pushing shaft 15, a center portion of the joystick gripping member 2 is pushed by an end of the third pushing shaft 16, so that the enter operation of the joystick switch 1, i.e., an operation of pushing a center thereof is performed.

Operation states of elements of the jig for a durability test of a joystick switch for a vehicle according to an exemplary embodiment of the present invention will be explained with reference to FIG. 4.

The control unit of the jig for a durability test of a joystick switch for a vehicle according to an exemplary embodiment of the present invention receives signals from the switch 18 and controls the operations of the solenoid valves 17-1, 17-2, and 17-3 and the step motor 24 on the basis of the signals from the switch 18. The solenoid valve and a hydraulic or a pneumatic cylinder are introduced as examples of a linear driving member.

The first solenoid valve 17-1 and the second solenoid valve 17-2 is a solenoid valve which is controllable to three positions, i.e., an advanced position, a neutral position, and a retreated position, and the third solenoid valve 17-3 is a solenoid valve which is controllable to two positions, i.e., an advanced position and a neutral position.

The first solenoid valve 17-1 and the second solenoid valve 17-2 respectively moves the first and the second pushing shafts 14 and 15 to the advanced position, the neutral position, and the retreated position, thereby controlling the operations of pushing an upper portion, a lower portion, a left portion, and a right portion of the joystick switch 1. The third solenoid valve 17-3 moves the third pushing shaft 16 to the advanced position and the retreated position, thereby controlling the operation of pushing a center of the joystick switch 1, i.e., the enter operation.

The control unit detects whether the plate 11 is positioned at the reference position, i.e., at a rotation angle of 0 degree on the basis of the signal of the first switch 18-1, and whether the plate 11 is rotated by 45 degrees on the basis of the second switch 18-2.

The step motor 24 is controlled by the control unit to rotate the plate 11 in a forward direction or in a reverse direction between the reference position and the position rotated by 45 degrees.

Operating sequence of the jig for a durability test of a joystick switch for a vehicle according to an exemplary embodiment of the present invention will now be explained with reference to FIG. 4 and FIG. 5.

First, at step S1, it is determined whether the plate 11 is set to be positioned at the reference position (0°) by the first switch 18-1.

If it is determined that the plate 11 is positioned at the reference position (0°), the control unit controls the first solenoid valve 17-1 to move the first pushing shaft 14 forward, thereby performing the operation of pushing an upper portion of the joystick switch 1, i.e., the pushing operation in a direction of 0 degree, at step S2.

After the operation of pushing the upper portion of the joystick switch 1 is performed, the control unit controls the first solenoid valve 17-1 to return to the neutral position so as to return the first pushing shaft 14 to the neutral position, thereby achieving the neutral state of the joystick switch 1, at step S3.

Subsequently, at step S4, the control unit controls the first solenoid valve 17-1 to move rearward so as to retreat the first pushing shaft 14, thereby performing the operation of pushing the lower portion of the joystick switch 1, i.e., the pushing operating in a direction of 180 degrees.

Subsequently, at step S5, the control unit controls the first solenoid valve 17-1 to return to the neutral position such that the joystick switch 1 is in the neutral state.

Subsequently, at step S6, the control unit controls the second solenoid valve 17-2 to move forward so as to move the second pushing shaft 15 forward, thereby performing the operation of pushing the left portion of the joystick switch 1, i.e., the pushing operation in a direction of 270 degrees.

Subsequently, at step S7, the control unit controls the second solenoid valve 17-2 to return to the neutral position so as to return the second pushing shaft 15 to the neutral position, so that the joystick switch 1 returns to the neutral state.

Subsequently, at step S8, the control unit controls the second solenoid valve 17-2 to move rearward so as to retreat the second pushing shaft 15, thereby performing the operation of pushing the right portion of the joystick switch 1, i.e., the pushing operation in a direction of 90 degrees.

Subsequently, at step S9, the control unit controls the second solenoid valve 17-2 to return to the neutral position so as to return the second pushing shaft 15 to the neutral position, so that the joystick switch 1 returns to the neutral state.

Accordingly, the pushing operations in four directions of 0 degree, 180 degrees, 90 degrees, and 270 degrees are completed.

Then, at step S10, the control unit operates the step motor 24 so as to rotate the plate 11 by 45 degrees. At this time, the control unit controls the rotation of 45 degrees of the plate 11 using the second switch 18-2.

In a state that the plate 11 is rotated by 45 degrees, the control unit controls the first solenoid valve 17-1 to move forward so as to move the first pushing shaft 14 forward, thereby performing the pushing operation in a direction of 45 degrees of the joystick switch 1 is performed, at step S11.

That is, when compared to the step S1, the operation that the first pushing shaft 14 moves forward by the first solenoid valve 17-1, thereby the upper artificial finger 12 pushes the joystick switch 1 is equal to the step S1, but since the entire portion of the operating part 10 including the artificial finger 12 is rotated by 45 degrees by the rotation of 45 degrees of the plate 11, the upper artificial finger 12 pushes the joystick switch 1 in a direction of 45 degrees.

Subsequently, at step 12, the control unit controls the first solenoid valve 17-1 to return to the neutral position so as to return the first pushing shaft 14 to the neutral position, so that the joystick switch 1 is in the neutral state.

Subsequently, at step 13, the control unit controls the first solenoid valve 17-1 to move rearward so as to retreat the first pushing shaft 14, thereby performing the operation of pushing the joystick switch 1 in a direction of 225 degrees.

Subsequently, at step S14, the control unit controls the first solenoid valve 17-1 to return to the neutral position so that the joystick switch 1 is in the neutral state.

Subsequently, at step S15, the control unit controls the second solenoid valve 17-2 to move forward so as to move the second pushing shaft 15 forward, thereby performing the operation of pushing the joystick switch 1 in a direction of 315 degrees.

Subsequently, at step 16, the control unit controls the second solenoid valve 17-2 to return to the neutral position so as to return the second pushing shaft 15 to the neutral position, so that the joystick switch 1 is in the neutral state.

Subsequently, at step S17, the control unit controls the second solenoid valve 17-2 to move rearward so as to retreat the second pushing shaft 15, thereby performing the operation of pushing the joystick switch 1 in a direction of 135 degrees.

Subsequently, at step S18, the control unit controls the second solenoid valve 17-2 to return to the neutral position so as to return the second pushing shaft 15 to the neural position, so that the joystick switch 1 is in the neutral state.

Accordingly, the operations of pushing the joystick switch 1 in the four directions of 45 degrees, 225 degrees, 135 degrees, and 315 degrees are completed.

Subsequently, at step S19, the control unit controls the step motor 24 such that the operating part 10 including the plate 11 reversely rotates by 45 degrees. At this time, the first switch 18-1 detects whether the plate 11 is returned to the reference position (0°).

Subsequently, at step S20, the control unit controls the third solenoid valve 17-3 to move forward so as to move the third pushing shaft 16 forward, thereby performing the operation of pushing the center portion of the joystick switch 1.

Subsequently, at step S21, the control unit controls the third solenoid valve 17-3 to retreat so as to retreat the third pushing shaft 16 the neutral position.

One cycle of a durability test of a joystick switch using the jig for a durability test of a joystick switch for a vehicle according to an exemplary embodiment of the present invention is completed by sequences as described above.

Generally, the durability test of the joystick switch is repeated in 5,000 to 10,000 times, and according to an exemplary embodiment of the present invention, the control unit repeats the cycle shown in FIG. 5.

The jig for a durability test of a joystick switch for a vehicle according to an exemplary embodiment of the present invention has following advantages.

Firstly, the use of the jigs of the present invention can provide a durability test that is as precise as a test where a person uses the joystick switch.

Secondly, the jigs according to the present invention can be used for a durability test of an integrated manipulation switch (e.g., four-direction or eight-direction joystick+enter (select)+jog shuttle/dial) as well as telematics terminal through a simple modification, thereby being able to widely applied to durability tests of vehicle parts.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A jig for a durability test of a joystick switch for a vehicle, comprising:
(a) an operating part having at least two artificial fingers configured to be able to grasp and push the joystick switch in a plurality of directions and being disposed to be opposite to each other; and
(b) a supporting member to support the operating part.

2. The jig of claim 1, wherein the operating part further comprises:
(a) a plate supported by the supporting member, arranged in a vertical direction and having a plurality of gear teeth thereon;
(b) at least one linear driving member one end of which is fixed to the plate and extending to a forward direction;
(c) at least one pushing shaft connected to the linear driving member and moving forward and rearward; and
(d) at least one link member connecting the artificial fingers and the pushing shaft such that the artificial fingers operate in opposite directions.

3. The jig of claim 1, wherein the finger comprises an upper finger, a lower finger, a left finger and a right finger, wherein the upper and lower fingers are arranged to be opposite to each other in a vertical direction and the left and right fingers are arranged to be opposite to each other in a horizontal direction.

4. The jig of claim 1, wherein the finger comprises a circular arc rail having a circular arc guide at the rear side of the finger, the circular arc extending along with a guide hole formed in the finger so that the finger can move along with the circular arc guide when the link member moves the finger moves.

5. The jig of claim 2, wherein the pushing shaft comprises a first pushing shaft and a second pushing shaft.

6. The jig of claim 2, wherein the linear driving member comprises a first linear driving member connected to the first pushing shaft and configured to move the upper and the lower fingers in opposite direction, and a second linear driving member connected to the second pushing shaft and configured to move the left and the right artificial fingers in opposite direction.

7. The jig of claim 6, wherein the first and the second linear driving members are configured to respectively move the first and the second pushing shafts to advanced positions, neutral positions, and retreated positions.

8. The jig of claim 6, wherein the linear driving member further comprises a third linear driving member disposed at a center portion of the plate and the pushing shaft further comprises a third pushing shaft connected to the third linear driving member so as to be movable forward and rearward, and an end thereof extended so as to be able to push a center of the joystick switch, so that a test operation of pushing the center of the joystick switch can be performed by forward and rearward movements of the third pushing shaft.

9. The jig of claim 2, wherein the linear driving member is a solenoid valve.

10. The jig of claim 2, wherein the link member comprises:
(a) a vertical center link arranged in a vertical direction, a center portion of which is pivotally connected to a fixed supporting member fixedly connected to the plate;
(b) an upper connecting link and a lower connecting link respectively connected to an upper end of the vertical center link and an end of the upper artificial finger, and to an lower end of the vertical center link and an end of the lower artificial finger;
(c) a horizontal center link arranged in a horizontal direction, a center portion of which is pivotally connected to the fixed supporting member;
(d) a left connecting link and a right connecting link respectively connected to a left end of the horizontal center link and an end of the left artificial finger, and to a right end of the horizontal center link and an end of the right artificial finger; and
(e) a first transmitting link connecting the first pushing shaft and one of the upper and the lower connecting links, and a second transmitting link connecting the second pushing shaft and one of the left and the right connecting links.

11. The jig of claim 2, wherein the plate is rotatably supported by the supporting member.

12. The jig of claim 1, further comprising a driving part connected to the operating part, which is adapted to be able to move the operating part in a plurality of directions.

13. The jig of claim 12, wherein the driving part comprises a step motor rotating the plate.

14. The jig of claim 13, wherein the driving part further comprises a driving gear the teeth of which are configured to fit the teeth of the plate.

15. The jig of claim 13, wherein the step motor is configured to rotate the plate by 45 degrees in a forward direction and in a reverse direction, such that operations of pushing the joystick switch in four directions by the first and the second linear driving members in a state that the plate is positioned at a reference position without being rotated are possible and operations of pushing the joystick switch in four directions by the first and the second linear driving members in a state that the pate is positioned at a position rotated by 45 degrees are possible, thereby the joystick switch being pushed in eight directions.

16. The jig of claim 15, wherein an operation of pushing the joystick switch in a forward direction by a forward and a rearward movements of the third pushing shaft caused by the third linear driving member is performed after performing previous pushing operations in four directions at the reference position of the plate and pushing operations in four directions at a state in which the plate is rotated by 45 degrees and before performing subsequent pushing operations in four directions at the reference position of the plate and pushing operations in four directions at a state in which the plate is rotated by 45 degrees.

17. The jig of claim 2, wherein the operating part further comprises (a) a detection rod connected to a rotating axis of the plate and (b) a switch configured to be switched according to an operation of the detection rod so as to detect rotation of the plate.

18. The jig claim 1, further comprising a joystick gripping member grasping the joystick switch so that the artificial finger operates the joystick switch via the joystick gripping member.
